(19) United States
(12) Patent Application Publication
(10) Pub. No.: US 2006/0032986 A1
(43) Pub. Date: Feb. 16, 2006

(54) Reusable thrust-powered sled mounted on an inclined track for launching spacecraft and airborne vehicles at supersonic speeds

(76) Inventors: David Maker, Huntsville, AL (US); Carlton Wade Meyer, El Cerrito, CA (US)

Correspondence Address: David Maker, 7807 Hilton Dr, Huntsville, AL, 35802, US

(21) Appl. No.: 10/859,712

(22) Filed: Jun. 3, 2004

(51) Int. Cl. B64G 1/40

(52) U.S. Cl. 244/171.6; 244/63; 244/171.3

(57) ABSTRACT

This invention will allow a reusable thrust-powered sled mounted on an inclined track to launch spacecraft or airborne vehicles from earth at supersonic speeds using existing technology properly integrated into an inclined track system. If launched up a tunnel track, a rear blast shield can trap the rocket exhaust to provide a pneumatic boost upon launch. The sled can also launch ramjet or scramjet powered vehicles from earth by achieving the Mach 2+ speed necessary to ignite their engines. This system is much safer than the traditional method of launching rockets since weather is less a factor and the launch can be aborted if problems develop. Moreover, it is far less costly since the engines on the sled can be reused hours after a launch and the track can accommodate a variety of sleds to launch objects of many different sizes.

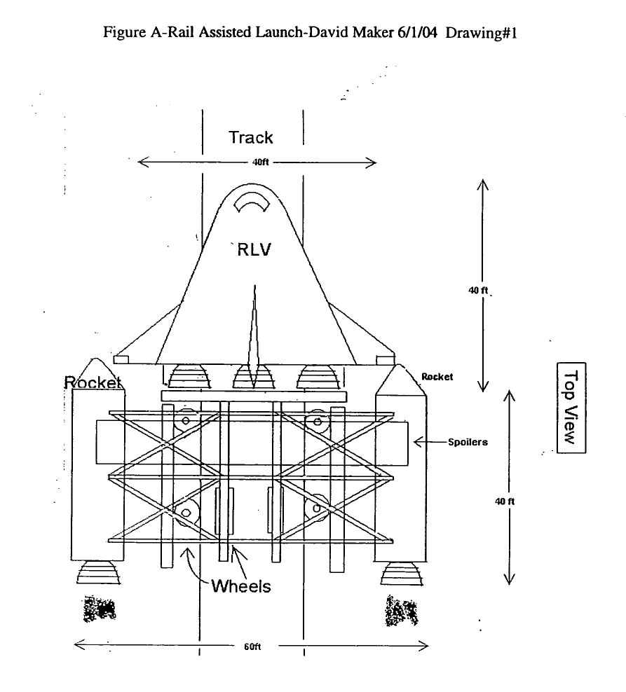

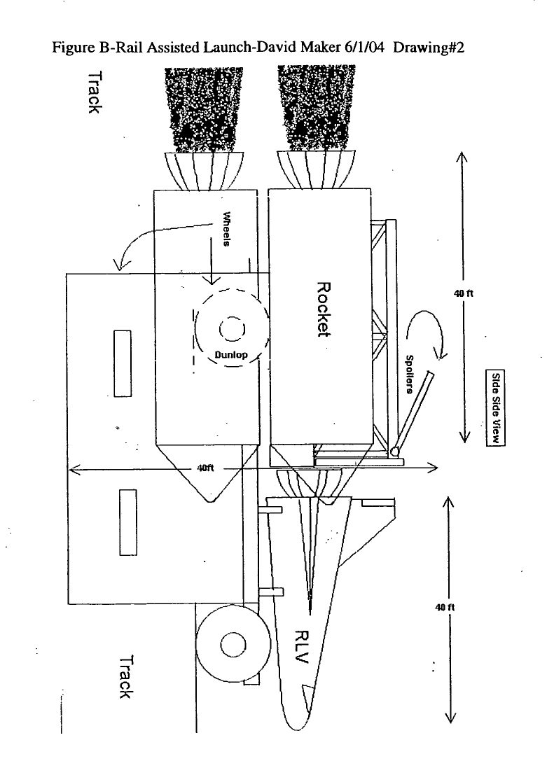

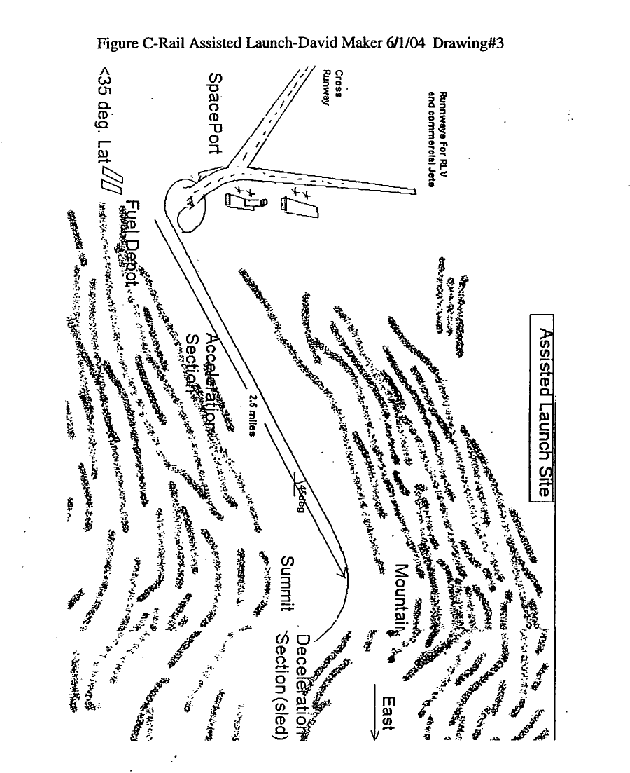

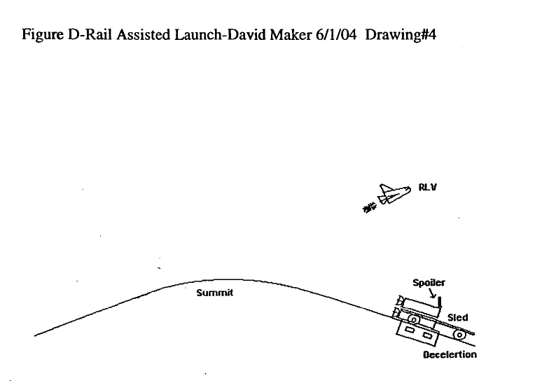

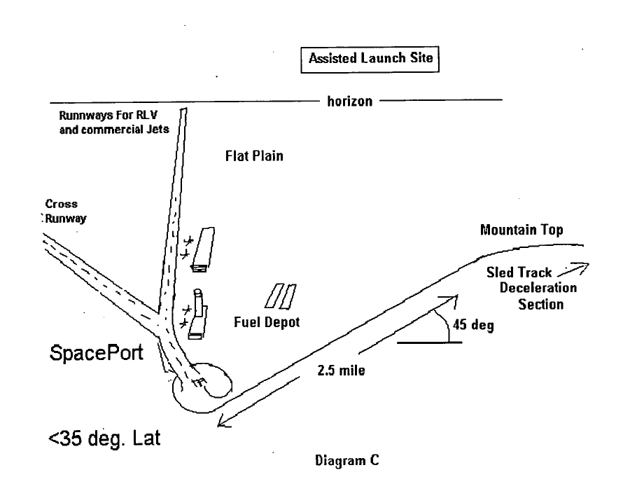

### CROSS-REFERENCE TO RELATED APPLICATIONS

Not Applicable

### STATEMENT REGARDING FEDERALLY SPONSORED REASEARCH AND DEVELOPMENT

There was no Federally sponsored research or development involved in this patent.

### BACKGROUND OF THE INVENTION

Mankind has been unable to find an inexpensive method of launching large objects into space. For the past 40 years, the only method has been multi-stage rockets. There has always been great interest in a single-stage Reusable Launched Vehicle (RLV). In fact, today's “Space Shuttle” was envisioned as a single-stage vehicle, but that proved impractical. NASA canceled a more recent attempt at a single-stage design, the X-33, in January 2001 when problems proved insurmountable. The solution is an “assisted launch” to propel the RLV to supersonic speeds before it fires its engines, which also allows scramjet engines to be used. In that regard note that the space shuttle uses half its fuel to reach 1000 mph (only 1/18 the final orbital speed) and also note that it takes a lot of fuel to lift a lot of fuel, thus giving the RLV even 1/12 the mach 24 orbital velocity is enough to attain orbit. Numerous discussions by the authors of this patent led us to realize that current technology will allow a thrust-powered sled mounted on an inclined track system to solve this problem.

### BRIEF SUMMARY OF THE INVENTION

No one has considered using proven thrust propulsions systems, like gas jet turbine or rocket engines, mounted on a miles-long inclined track system for assisted launch. Our figures prove that large RLVs can be propelled to supersonic speeds using jet or rocket powered sled mounted on an inclined track. This could also be used to launch a variety of airborne vehicles. A major challenge is identifying large mountains with lengthy inclined slopes on which to build the tracks, unless a tunnel is cut. It may begin on an incline directly from a launch pad, or it may begin on a horizontal track and ramp up to the desired inclined launch angle. A review of each element of the title is helpful:

Reusable Thrust-Powered Sled Mounted on an Inclined Track for Launching Spacecraft and Airborne Vehicles at Supersonic Speeds

Reusable—keeps launch costs reasonable compared to the traditional method of disposable rocket stages.

Thrust-powered—can be rockets, gas jet turbines, or both.

Sled—the object to be launched and the rocket or jet engine will be mounted on a sled, similar to a railroad flatcar, with grips to prevent it from flying off at high speeds. This may be one long sled, or a sled for the thrust engines connected to another sled with the object to be launched.

Inclined Track—can be mounted on steel rails with grips or wheels, or using magnetic levitation monorail technology, or slide along an ice coated surface. The rails will be mounted on a lengthy inclined track. If inclined nearly vertical in a tunnel track, it may use slots that slide along grooves in the tunnel.

Spacecraft—this system provides an assisted launch to reduce the size and weight of spacecraft. It can also reach speeds needed for the ignition of ramjet or scramjet engines.

Airborne Vehicles—this system is useful for launching a variety of aircraft and missiles.

Supersonic speeds—launch speeds in excess of Mach are possible.

### BRIEF DESCRIPTION OF THE FOUR DRAWINGS

FIG. A—a top view of an X-33 size RLV mounted on a rocket-powered sled

FIG. B—a side view of an X-33 size RLV mounted on a rocket-powered sled

FIG. C—an example of an inclined track assisted-launch site

FIG. D—an RLV just launched at the summit by a rocket-powered sled

### DETAILED DESCRIPTION OF THE INVENTION

Using proven jet and/or rocket engines to launch objects off a sled mounted on an inclined track will work. This is not a theory; the technology has existed for years. This idea falls under the category of “assisted launch”. Several ideas have been proposed is the past using different launch techniques. A brief review follows:

Methods of Assisted Launch

Gun fired—In his 1865 book “From the Earth to the Moon” Jules Vern proposed a gun to launch people to the moon. The idea of a “Super Gun” to launch objects into space became a reality in the 1960s when a team lead by Dr Gerald Bull successfully launched small satellites into space. In recent years, Jules Verne Launcher Co has been experimenting with using gas as a propellant. The largest commercial guns will subject satellites to 1000 g's for approximately one second. Although this strain can be met by circuit designs, it may require hardening of components like solar cells or deployable antenna structures. The primary drawback is the g forces are far, far too great for manned flight.

Pneumatic launch—This is similar to a gun launch, but at much lower velocities. To launch an RLV, it would need a huge lengthy tube with side slots for wings. If slow non-detonation heating with pure hydrogen gas is used, Mach 1+ velocities can be achieved giving far more payload capabilities. This is a promising idea for which no patent exists, but expensive and unproven.

Electromagnetic launch—A 1985 project at the Lawrence Livermore National Laboratory concluded that the cost per joule of just about any kind of electric gun is so high that it's basically prohibitive. Several similar patents exist which propose using this technique, such as: Electromagnetic transportation system for manned space travel (U.S. Pat. No. 7,795,113). The Holloman aerodynamic horizontal test track in New Mexico has achieved Mach 8 using electromagnetic propulsion for small objects, but cost and technical problems such as too small a thrust with large vehicles have impeded using this technology for assisted space launch.

Steam catapult—The best-known assisted launch system is used by the US Navy to fling jet aircraft from aircraft carriers. A larger catapult would need to be about four times the length of today's carrier catapults to get Mach1 for comparable g's of ordinary jet carrier takeoff; carrier catapults routinely accelerate (fully loaded F-18) jets to about 160 mph. However, such system requires a stronger RLV body to withstand the force of the launch, and a system to launch an RLV would be massive.

Piggybacked on a large aircraft—Although the Space Shuttle is moved this way, it is always empty. At launch when full of fuel, an orbiter (with non trivial payload capabilities) is too heavy to be lifted by any known aircraft. Designing a huge jet aircraft for this purpose presents its own set of problems. However, a patent exists for this idea: Hypersonic and orbital vehicles system (U.S. Pat. No. 6,257,527)

Towing by a large aircraft—Some people have suggested that an RLV could be towed like a glider to high altitudes. However, the surface to volume ratio is small for a single-stage RLV given that surface is deadweight tiling and volume is fuel. Thus an RLV must be “plump”, with little in the way of wings and so lacking a sufficient lifting body when full of fuel at launch. In short, an RLV creates so little lift when fully loaded that it couldn't leave the runway.

Reusable rocket powered airplane—is described in patent (U.S. Pat. No. 6,119,985). This would be a huge aircraft requiring a massive runway to get off the ground. This could not be an RLV that could attain orbit since it would have the same deadweight problems as the X-33. However, a smaller rocket-powered aircraft should work using the inclined rail launch technique of this patent.

Thrust powered track-mounted sled—There are no patents close to our simple idea proposed in this patent. Using a thrust-powered track-mounted sled, a large object can be accelerated to supersonic speeds up an incline. An added advantage is the launch occurs several miles above sea level where the air is much thinner, saving even more fuel. This technique could have been used with the NASA X-33 program.

The X-33 Failed without Assisted a Launch

NASA hoped to build the X-33 RLV as the world's first single-stage to orbit spacecraft. This would allow safer and inexpensive space launches, compared to the “Space Shuttle” which requires an expensive first-stage booster rocket. However, after many years of research design incorporating the latest technologies, NASA was unable to develop a design that would allow the X-33 to reach orbit under its own power. As a result, the X-33 project was canceled in January of 2001. That same year, after discussions between the two authors of this patent regarding “assisted launch”, it was clear that the X-33 could make orbit with the assisted launch technique described in the patent.

The Value of Initial Velocity which Assisted Launch Provides

The core of the problem is that given the choice between a large initial mass m₀ launch system and a large initial velocity v₀ system. The space shuttle uses up approximately half its fuel just reaching 1/18 orbital speed for example. So let us make the case for the large v₀ option. Let m₀ be the total initial fully loaded mass of the rocket, ‘m’ the mass after the fuel is expended, V=exhaust velocity=4500 m/s, (calculated from H₂+O Isp) v=7.7 km/sec orbital velocity, t=8.5 min time to orbit without having the initial velocity v₀. “R” the usual value of m₀/m for the case v₀=0. The t(vₒ) term is the decrease in time (term) to orbit due to the fact of having an initial velocity. So this time is subtracted from the real time to get an effective time. Let m₀ be the total initial fully loaded mass of the rocket, ‘m’ the mass after the fuel is expended, V=exhaust velocity=4500 m/s, (calculated from H₂+O Iₛₚ) v=7.7 km/sec orbital velocity, t=8.5 min time to orbit without having the initial velocity v₀. “R” the usual value of m₀/m for the case v₀=0. The t(vₒ) term is the decrease in time (term) to orbit due to the fact of having an initial velocity. So this time is subtracted from the real time to get an effective time. D=½ at² if the initial velocity is zero. Thus to get out of the atmosphere and headed in a nearly horizontal direction at about 70 miles or 100 km for 3 g climb we have 100×10³=½ 3(9.8(0.707))t². So t=98.1 sec. But if an initial velocity of mach2=700 m/s was given we have with an average slant angle of 45 degrees so that the vertical acceleration is on average 0.707(9.8) D=½ at²+vₒt so that 100×10³=½3(9.8(0.707))t²⁺⁷⁰⁰t or

$$t = \frac{- 700 \pm \sqrt{{700}^{2} - 4 ( - {10}^{5} ) ( 10.4 )}}{2 ( 10.4 )} = 70 sec$$

plus about ˜6 sec for the engines to start up so that the t(v₀)=(98.1+6)−70=34.1 sec≡tₛ (saves ˜0.5 minute in flight, almost to maxQ from 50-85 sec), V=4500(m/s)=isp for H₂+O. t=8.5 min., v₀=700 m/s=Mach2 with pneumatic (or catapult) nondetonation heating. Thus in the rocket equation (resulting from integration of the impulse equation): v=vₒ+gtₛ−gt+V ln(mₒ/m). The gt term represents the loss in velocity due to work against gravity on the nearly vertical segment of the path, the tₛ is the above loss in this time due to the assisted launch. So dividing by V and taking the exponential and solving for mₒ/m:

$$exp ( \frac{v + g ( t - {t}_{s} ) - {v}_{o}}{V} ) = \frac{{m}_{0}}{m} = 5.5$$

Without the assisted launch we have:

$$exp ( \frac{v + gt}{V} ) = \frac{{m}_{0}}{m} = 6.94$$

so that the gain in allowed mass is 6.94/5.5=1.26. It is well known that a titan first stage could orbit. Shortening it by half given the same fuel volume gives it 1/√2 less surface area and therefore 1.26×1.414=1.78, gives it the capacity to carry nearly two times the deadweight. This deadweight could be reentry tiling plus payload. The ability to add this much extra mass in the form of reentry tiles would clearly still have orbital possibilities. The problem has been for most recent assisted launch analysis that of not considering the pre maxQ vertical component of gt(vₒ) term in the impulse equation. This represents the work that would have had to have been done against gravity had the larger fuel load been carried up. This term is about half the vo itself. It represents essentially a “amplification” of the effect of assisted launch. Nowhere in the most recent assisted launch reports is any analysis done of the impulse equation, let alone this central concept (saving time working against gravity with an otherwise large payload) to assisted launch.

Thus the booster can be 0.7 times smaller for unmanned payloads, nearly half the size! This would make it so that even the large X-33 RLV could make it into orbit! The original X-33 design launched vertically from a dead-start could reach only about Mach 15, needing Mach 24 to make orbit. An assisted launch could close that gap. The ability to add this much extra mass in the form of reentry tiles (with a modification to X-33 like lifting body shape) would clearly have orbital possibilities.

The key is to consider the pre maxQ vertical component of gt(vₒ) term in the impulse equation. This represents the work that would have had to have been done against gravity had the larger fuel load been carried up. This term is two to three times larger than the vₒ itself. It represents essentially a large “amplification” of the effect of assisted launch.

For an example of a rocket sled inclined rail assisted launch, we will use four 656,000 lb thrust Boeing RS-68 rocket engines (two on each side of a sled) to launch an X-33 size RLV with sufficient speed to make orbit.

Parameters for Example

Launch weight of an X-33=273,000 lbs
Thrust of RS-68=656,000 lbs each
   Newton's Second Law used to Calculate Required Thrust
Newtons's 2^{nd} law F=ma
Sum of Forces=Air Resistance+Thrust+gravity+Friction=ma
4×656,000 lbs=2,624,000 lbs Thrust
   Air Resistance:
ρV=m, V=Ax so dm/dt=pdV/dt=pA(dx/dt)=ρAv in
D≈(½)CρAv²
Given typical vehicle drag coefficient for streamlined vehicle D=0.5, ρ≈1 kg/m³ at
v≈2×340 m/sec then
D≈(½)CρAv²==0.5(0.5)(1 kg/m³)(10 m×3 m)(2*340 m/s)²=3,468,000N=778,000 lbs.
   Friction to contributes little here. Above mach 1 Cₚ is complex and in fact is a variable and also can be made smaller this nominal value by design changes in the RLV.
   Gravity Force
Take the sled plus rocket motors to be about 100,000 lbs weight at top of track since all the fuel has been used in the rocket motors. So F_{g}=mg sin θ=(273,000+100,000)sin 45°=263,711 lbs
   Total Force Required for 6 gs
Total Force=air resistance+Thrust+gravity+Friction=ma=m6*9.8
Total Force=D+Thrust+F_{g}=m6*9.8
Thrust−778,000−263,711=ma=(263,000/32)6*32=1,578,000=lbs

So the required Thrust=2,620,000 lbs in comparison to 2,624,000 lbs thrust for four RS-68 engines. Note this represents the maximum thrust needed. This is because at the bottom the drag force is near zero even though there is on the order of 600,000 lbs fuel in the four shortened RS-68s there, so that the added gravity force is 600,000 sin 45≈424,000 lbs, still far less than the drag force at the top given that this fuel has been expended by the time the sled reaches the top. So the thrust is sufficient here.

The track could be mounted on raised concrete, like an expressway ramp, about 15 feet wide so that wheels can be on the side as well as the top, like a monorail, so the sled cannot leave the track. The rockets are mounted on the sides about 15 feet from the track and face slightly away from the track so their exhaust does not damage the track.

A spoiler can be used at the top of the track along with other brakes to help keep the sled moving on a downward moving track and slow it down while the RLV leaves according to Newton's First Law. Large decelerations of the sled are possible after the RLV containing the people is launched. The 6 g thrust requirement is provided by four RS-68s stacked in pairs on each side.
Track Length for 6 g Acceleration and Mach 2 Final Velocity

$$v = \sqrt{2 as} so s = \frac{{v}^{2}}{2 a} = \frac{{( 2 * 340 )}^{2}}{2 * ( 6 * 9.8 )} = 3 , 932 m \approx 4 km \approx 2.5 miles$$

So the inclined track must be on the order of 2.5 miles (13,200 feet) long. Since the Earth has dozens of mountains over 20,000 feet tall, building rail ramp up a mountain at a 45-degree slope is certainly feasible; using the same construction techniques used to build interstate highways and rail lines through large mountain ranges. But a curved 2.mile long track with more curvature near the low velocity end can be made with a vertical displacement requirement of only ⅔ mile, about 4000 feet allowing for track construction in plenty of geographical locals.

Example of a Tunnel Track

A more expensive option is to cut a large inclined tunnel for the track. This may seem ambitious, but the world has several railway tunnels over 30 miles long. A near vertical 2.5-mile tunnel would not even make the list of the world's 250 longest railway tunnels. This makes site selection much easier since the ideal direction and angle of launch can be chosen, weather is rarely a factor, and a tunnel reduces noise and environmental concerns.

Most likely, the tunnel entrance would be horizontal at the base of a mountain leading to a near horizontal launch site deep inside. Ideally, the tunnel would be sealed and the air pumped out prior to launch to reduce air resistance as the craft moves upward. This also permits a huge blast shield at the rear of the sled to trap the rocket exhaust upon launch to provide a pneumatic boost. Huge doors would pop open at the top of the tunnel as the sled releases its payload.

Example of a Gas Jet Turbine Powered Sled

This inclined track system can also launch ramjet or scramjet-powered aircraft and spacecraft. Their simple high-speed engines require a speed of over Mach 2 before the airflow is sufficient to ignite their fuel. NASA is now testing the small X-43 Hypersoar aircraft with hopes of achieving a top speed of Mach 7-10. They currently use an expensive and awkward method of igniting the X-43's engine with an assisted launch from a large aircraft and a disposable rocket booster. On Jun. 2, 2001, an X-43 was lost during testing after its Pegasus booster rocket veered off course but a more recent test was successful.

Our inclined track system can launch much larger X-43 type aircraft at a far lower cost. Rocket engines can provide the needed thrust, but a sled using only jet turbine engines could also do the job. The F110-GE-129 gas turbine jet engine used by the US Air Force F-15E fighter produces 29,000 lbs of thrust. Since its two engines can propel that aircraft to Mach 2.5+, two or more engines mounted on a sled should be able to propel an X-43 to the required speed for scramjet ignition and launch from an inclined track system.

Variables for Inclined Track Launch Systems

Each launch site must be custom designed based on a variety of factors:

Location of launch site—a location closer to the earth's equator is greatly advantageous for spacecraft launches, ideally pointing east. A large steep mountainside in needed to support the inclined track, unless a tunnel is cut. A rural area is best because of the launch noise and sonic booms.

Size of potential vehicles—the weight of the objects to be launched and their aerodynamic characteristics determine the length of track and thrust required.

Desired Speed of Launch—faster is usually better, but the thrust needed, angle of launch, and length of track are constraints.

Desired Angle of Launch—spacecraft going for orbit are best at near vertical take-off from the end of the track because of the work required to push air to attain near vertical trajectory. Of course the higher the angle the more thrust needed to achieve the desired speed, and rail/track construction becomes more difficult, unless a tunnel is used.

Track Choice—The US Navy's horizontal aerodynamic and ejection seat test track at China Lake has achieved Mach 4 on steel rails. Wheeled sleds with Dunlop aluminum wheeled jet powered vehicles have achieved Mach 1. Magnetic Levitation (Mag-Lev) now used for high-speed trains eliminates friction, but is very expensive for the high thrusts needed here. (We are not proposing electrical propulsion for space launch; just that Mag-Lev technology is an option for suspending the sled on a rail). Iced rails or bobsled type tracks have not been used, however, frozen lakes have been used to achieve near Mach ground speeds. The track system may be of any type, monorail, dual track, or multiple rails, slot and groove, or even an iced sliding track. The track can be built up a mountainside or inside a tunnel. The sled may nearly fly through the air using any type of ground-mounted track to remain safely on course.

Engine Choice—two types of engines can produce the thrust needed. Supersonic gas jet engines have been used for decades. While jet engines are much cheaper to operate, rocket engines can provide much more thrust.

Maintenance and Support Choice—a system may use a dead start in which the object to be launched is attached to a thrust-powered sled mounted on an inclined track and launched directly with a large “blast off”. A second option is for a horizontal support area in which the launch begins on a horizontal rail and ramps up to the desired angle on the track. At some locations, it is impractical to locate the support areas near the mountain base, so the track may begin with several miles of horizontal rails where a locomotive pushes the sled up to the inclined area before the thrust engines ignite. Ideally, a large airfield will exist nearby to allow spacecraft to land for easy reuse.

Braking System—Unless the sled is designed to go airborne and fly to an airbase (or parachute down) for reuse after launching the RLV, some braking mechanism is needed to quickly stop the sled on the track after release of its payload. There are a dozen possible methods using simple existing technology, such as: curving the track, water braking, spoilers as air brakes, or hook and cables.

1. We claim this invention will allow a reusable thrust-powered sled mounted on an inclined track to launch spacecraft or airborne vehicles from earth at supersonic speeds using existing technology.

2. We claim this invention will allow a reusable thrust-powered sled mounted on an inclined track to launch ramjet or scramjet powered airborne vehicles from earth by achieving the Mach 2+ speed necessary to ignite their engines using existing technology.
